(19) United States
(12) Patent Application Publication
(10) Pub. No.: US 2017/0132372 A1
(43) Pub. Date: May 11, 2017

(54) INTEGRATING AND/OR ADDING LONGITUDINAL INFORMATION TO A DE-IDENTIFIED DATABASE

(71) Applicant: KONINKLIJKE PHILIPS N.V., EINDHOVEN (NL)

(72) Inventors: Reza SHARIFI SEDEH, Malden, MA (US); Yugang JIA, Winchester, MA (US); Daniel Robert ELGORT, New York, NY (US)

(21) Appl. No.: 15/344,837

(22) Filed: Nov. 7, 2016

Related U.S. Application Data
(60) Provisional application No. 62/253,717, filed on Nov. 11, 2015.

(51) Int. Cl. G06F 19/00; G06F 17/30

(52) U.S. Cl. CPC G06F 19/322; G06F 17/30321

(57) ABSTRACT

A method includes receiving a first set of de-identified records for individuals from a first type of database for a first set of entities. The first type of database does not include longitudinal information that links the first set of de-identified records across the first set of entities. The method includes receiving a second set of de-identified records for a single individual from a second type of database for a second set of entities. The second type of database includes longitudinal information that links the second set of de-identified records across the second set of entities including over time. The method includes integrating the first type of databases and the second type of databases, which matches the individuals and the single individual. The method includes adding longitudinal information to the first type of database for the individuals based on the longitudinal information of the second type of database.

### CROSS-REFERENCE TO PRIOR APPLICATIONS

This application claims the benefit of U.S. patent application Ser. No. 62/253,717, filed Nov. 11, 2015, which is incorporated herein in whole by reference.

### FIELD OF THE INVENTION

The following generally relates to de-identified databases and more particularly to integrating and/or adding longitudinal information to a de-identified database.

### BACKGROUND OF THE INVENTION

Various types of databases from administrative, to operational, to clinical, etc. exist. These databases have been used separately by researchers to approach their domain-specific research problems—i.e., administration, operations, or clinics. If integrated, these databases would provide richer and more beneficial information for use in healthcare services, solutions research, etc., and would facilitate doing research on a broader range of research projects, which are not limited only to one specific domain. For privacy, the records in such databases, as well as the source entities of the records, are de-identified. That is, all identities (e.g., names, social security numbers, etc.) of individuals are removed from the databases, and all identities of the entities with these records and/or databases are removed from the databases.

When such databases are available with only de-identified information, there is no straight-forward approach available to match patient records across the different databases. To match corresponding records across these databases and construct an integrated data set, the records have to be matched based on a set of non-uniquely identifying features (e.g. age, sex, weight, diagnosis, length of hospital stay, etc.). Unfortunately, this can be a tedious and time consuming task, requiring processing and memory for large volumes of information and is prone to matching error. In addition, even when matched, one of the matched de-identified databases may not include longitudinal information for a patient that links the record of the patient (e.g., each medical episode) for this database across different care settings and time.

### SUMMARY OF THE INVENTION

Aspects of the present application address the above-referenced matters and others.

According to one aspect, a method includes receiving a first set of de-identified records for individuals from a first type of database for a first set of entities. The first type of database does not include longitudinal information that links the first set of de-identified records across the first set of entities. The method includes receiving a second set of de-identified records for a single individual from a second type of database for a second set of entities. The second type of database includes longitudinal information that links the second set of de-identified records across the second set of entities including over time. The method includes integrating the first type of databases and the second type of databases, which matches the individuals and the single individual. The method includes adding longitudinal information to the first type of database for the individuals based on the longitudinal information of the second type of database.

In another aspect, a method includes receiving a first set of de-identified records for a first set of individuals from a first type of database for different entities and receiving a second set of de-identified records for a second set of individuals from a second type of database for the different entities. The method includes matching a first individual of the first type of database and a second individual of the second type of database that have a same unique identification and that share a predetermined percentage of entity codes of the individual with a fewer number of the entity codes. The method includes identifying the second individual has a record in the second type of database at a third entity, identifying multiple individuals in the second type of database at the third entity having a same unique identifier as the second individual, and identifying clinical information of the first individual and clinical information of each of the multiple individuals. The method includes matching the first individual to only one of the multiple individuals based on the clinical information.

In another aspect, a computing system includes a memory device configured to store instructions, including a record integration module, and processor configured to executes the instructions. The processor, in response to executing the instructions: identifies a set of features common across the at least two different databases, generates a unique identification for each of the individuals based on the set of features, computes a rarity coefficient for each of the individuals based on the set of features, matches entities of the first and second sets of the de-identified entities across the first and second types of databases based on the rarity coefficients, identifies the single individual has a record in the second type of database at a third entity, identifies multiple individuals in the first type of database at the third entity as having the same unique identifier as the single individual, identifies clinical information of the single individual and clinical information of each of the multiple individuals, and matches the single individual to only one of the multiple individuals based on the clinical information.

Still further aspects of the present invention will be appreciated to those of ordinary skill in the art upon reading and understand the following detailed description.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 schematically illustrates an example system with a database integration module.

FIG. 2 schematically illustrates an example of the database integration module.

FIG. 3 illustrates an example method for integrating de-identified databases.

FIG. 4 depicts an example for integrating de-identified databases.

FIG. 5 illustrates an example method for adding longitudinal information to a de-identified database.

FIG. 6 depicts an example of records for an individual in a first type of database across entities with no longitudinal information.

FIG. 7 depicts an example of records for the individual in a second type of database across the entities with longitudinal information.

FIG. 8 depicts adding longitudinal information to the database of FIG. 6 by integration with the database of FIG. 7.

### DETAILED DESCRIPTION OF EMBODIMENTS

The following generally describes an approach for adding, for an individual, longitudinal information to a de-identified database across multiple entities that does not include the longitudinal information through integration of the de-identified database with a different de-identified database across multiple entities that includes the longitudinal information for the individual. The integration, in one instance, includes matching de-identified records of an individual in the de-identified database and the different de-identified database using at least clinical information of the individual.

Suitable de-identified databases include healthcare based de-identified databases and/or non-healthcare based de-identified databases. Examples of such de-identified databases include, but are not limited to administrative, operational, clinical, and claims de-identified databases. For sake of brevity and clarity, the following is described with respect to healthcare records of individuals (e.g., patients) in clinical and claims de-identified databases. However, it is to be understood that this is not limiting, and the description herein also applies to other de-identified databases.

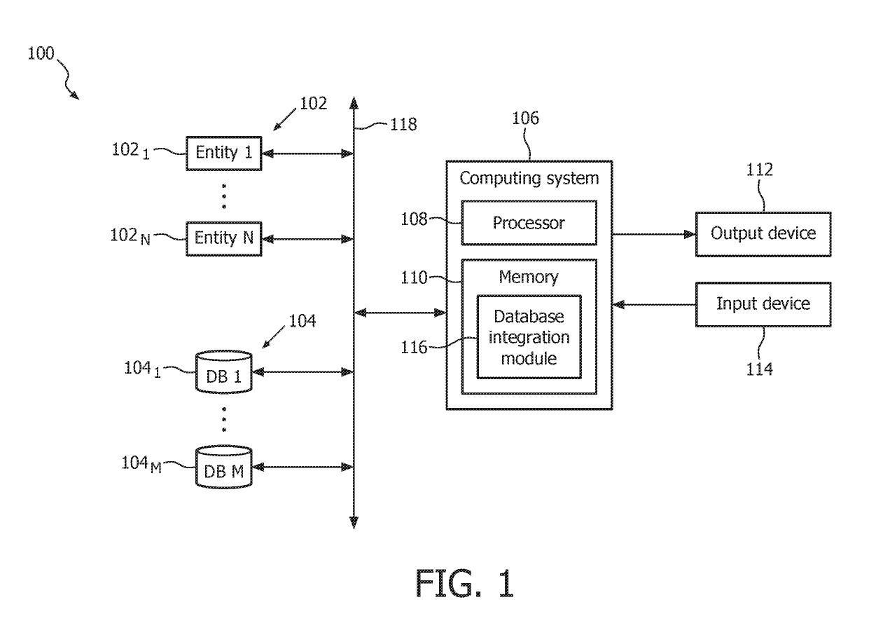

FIG. 1 illustrates a system 100. The system 100 includes a plurality of entities 102₁, . . . 102_{N} (collectively referred to as entities 102), where N is a positive integer greater than two (2). An entity 102, e.g., is a hospital, a clinic, a doctor's office, a commercial business, etc. Each entity 102 produces one or more different types of information for an individual (e.g., a patient in the context of a healthcare entity). A type of information, e.g., is administrative, operational, clinical, claims, and/or other types of information.

Each entity 102, in general, employs its own unique identification generating algorithm for creating and assigning an internal (i.e., within the entity 102) identifier for each individual of the entity 102. The information for an individual within the entity 102 is grouped together, labelled and linked with the identifier for that individual. Typically, no two entities 102 utilize the exact same algorithm. Thus, information for a same individual at two different entities is likely to be assigned different identities and cannot be readily matched.

The system further includes a plurality of databases 104₁, . . . , 104_{M} (collectively referred to as databases 104), where M is a positive integer equal to or greater than two (2). Each database 104 stores a particular type of the information, which is different from a type of information stored in another database 104. For example, one database 104 may store only clinical information while another database 104 stored only claims information. The information stored in each of the databases 104 is de-identified data in that all references to names of individuals and entities are removed.

A computing system 106 includes at least one processor 108 (e.g., a microprocessor, a central processing unit, etc.) that executes at least one computer readable instruction stored in computer readable storage medium (“memory”) 110, which excludes transitory medium and includes physical memory and/or other non-transitory medium. The computing system 106 further includes an output device(s) 112 such as a display monitor and an input device(s) 114 such as a mouse, keyboard, etc. The at least one computer readable instruction, in this example, includes a record integration module 116.

In the illustrated example, the entities 102, the databases 104 and the computing system 106 are all in communication with a network 118. The network 118 is wired and/or wireless. In a variation, the entities 102, the databases 104 and the computing system 106 are otherwise in communication. Furthermore, the entities 102, the databases 104 and the computing system 106 can be implemented through a computer apparatus and/or “cloud” based services.

The instructions of the database integration module 116, when executed by the at least one processor 108, cause the at least one processor 108 to integrate the databases 104. In one instance, the integrated databases provide more information about an individual relative to the individual databases. This results in improving the technology and reducing processing power and memory requirements for processing the data in the databases, e.g., for applications in services such as healthcare and solutions research. With these applications, longitudinal information from linked databases can be used to track a patient from one hospital visit or stay to another. Such data can be used to perform care continuum analytics or root-cause analytics based on the databases.

As described in greater detail below, in one non-limiting instance the integration includes matching entities in de-identified databases to link de-identified entities in the de-identified databases and then matching individuals based only on the records of those de-identified databases that are from the same entities. To refine the individual matching and increase the probability of exact individual matching, an additional dimension of information is taken into account; namely, the history (e.g., clinical, etc.) of the individual. Once integrated, the longitudinal information of an individual in one de-identified database can be used to create longitudinal information for the individual in another de-identified database.

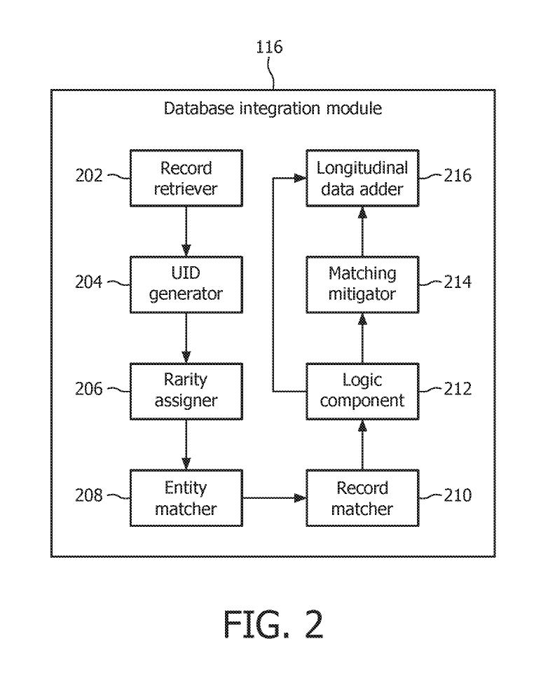

FIG. 2 schematically illustrates an example of the database integration module 116. The database integration module 116 includes a record retriever 202. The record retriever 202 retrieves records from all or a subset of the databases 104 for integration. This includes retrieving records from a de-identified database of a first type (e.g., clinical) that does not include longitudinal information and a de-identified database of a second type (e.g., claims) that includes longitudinal information. The de-identified database of the second type is used to add longitudinal information to the de-identified database of the first type. In this example, the de-identified database of the second type includes all the entities included in the de-identified database of the first type.

The database integration module 116 further includes unique identifier (UID) generator 204. The UID generator 204 generates a UID for each de-identified individual in the retrieved records. The UIDs can be stored in the memory 110 of the computing system 106, in one or more of the databases 104, and/or in another storage device(s). In this example, the UID generator 204 generates UIDs based on a UID algorithm, which utilizes common features of the databases 104. Examples of common patient features include: age, race, mortality, gender, hospital length of stay (LOS), hospital discharge location (DL), admission source (AS), diagnosis and/or other features. One or more of these features may have missing and/or erroneous values.

In one instance, a UID algorithm defines the following numeric coding scheme based on age, race, gender, mortality and LOS. A first set of digits (“X” xxxxxx) represents gender. In this example, a value of 1 indicates male, and a value of 0 indicates female. A second set of digits (x“X” xxxxx) represents race. In this example, a value of 5 represents race A. A third set of digits (xx“X” xxxx) represents mortality. In this example, a value of 1 indicates the patient is not alive, and a value of 0 indicates the patient is alive. A fourth set of digits (xxx“XXX” xx) represents LOS. A fifth set of digits (xxxxx“XX”) represents age. Other features and/or coding (e.g., alpha, alphanumeric, etc.) are contemplated herein.

Thus, for a patient record with the following common patient features: gender=male, race=A, mortality=not alive, LOS=122 days, and age=18 years old, the UID generator 204 generates the following UID: 15112218. Since age and LOS are numeric values and can be rounded up or down in different electronic record systems, a tolerance (e.g., of ±1 or other), in one instance, is used when generating a UID. That is, the patient in the above example could be anywhere from seventeen and half years old to eighteen and half years old. Similarly, the patient may have been discharged some time during the one hundred and twenty-second day, resulting in a LOS of 121 or 122 days, depending on whether the discharge day counts as a full day.

The database integration module 116 further includes a rarity assignor 206 that computes a rarity coefficient for each de-identified individual in the records from the databases 104 being processed based on a rarity algorithm. An example rarity coefficient for the example patient UID=15112218, using the rarity algorithm, is computed as shown Table 1.

TABLE 1
Example Rarity Coefficient Calculation
for Patient UID = 15112218.

| Gender | Race | Mortality | LOS (D) | Age (E) | Rarity |
|---|---|---|---|---|---|
| (A) | (B) | (C) | % >= | % <= | Coefficient |
| % male | % race A | % not alive | 122 days | 18 | A*B*C*D*E |
| 45.00% | 0.10% | 0.00% | 0.01% | 1.00% | 4.5 × 10⁻¹¹ |

From Table 1, the rarity coefficient for the example patient UID=15112218 is 4.5*10⁻¹¹, which means approximately, in every 22 billion patients, there is only one patient with a rarity coefficient as small as this patient's rarity coefficient. In general, the lower the rarity coefficients, the rarer the patient is in the database. Other rarity algorithms are also contemplated herein.

The database integration module 116 further includes an entity matcher 208 that matches de-identified entities across the databases 104. In one instance, the entity matching process is performed as follows. For each year of data in the two databases, hospitals in the clinical database are linked to their corresponding hospitals in the claims database. For this, the rarity coefficient threshold is set to a predetermined value (e.g., 10⁻¹⁰). Then, for each clinical hospital X, its patients with a rarity coefficient lower than the threshold is matched to the patients in the claims database. The number of patients in the clinical hospital X with a rarity coefficient lower than the threshold is n.

Next, a claims hospital Y that contains the patient records of at least a) five and b) 30% of the n patients in the clinical hospital X is identified and linked to the clinical hospital X. The patients of these two hospitals excluded from the rest of the hospital matching process. Then, the rarity coefficient threshold is scaled (e.g. multiplied by a ten or other scaling factor) and the process is repeated, until all the hospitals from the clinical database is linked to those of the claims database. This process is then repeated over different years. If the clinical hospital X has been linked to the claims hospital Y over different years, the clinical hospital X and the claims hospital Y are matched.

The database integration module 116 further includes a record matcher 210 that matches de-identified records across the databases 104 for each set of matched entities based on a record matching algorithm. Once the hospitals from the clinical database are matched to those of the claims database, the record matcher 210 performs the patient record matching between the patients in the two databases that are from the same hospitals. Hence, if the clinical hospital X and the claims hospital Y are matched, Patient A from the clinical hospital X is matched with Patient B from the claims hospital Y based on predetermined conditions.

In one instance, the record matcher 210 matches based on the following. If a de-identified individual A has a same UID as a de-identified individual B and the de-identified individual A and the de-identified individual B share at least 50% of the same International Classification of Diseases (ICD) codes of the individual (i.e., A or B) with the least number of ICD codes, the record matcher 210 deems the match successful. For example, if six of ten ICD codes have been assigned, respectively, to Patient A in the clinical database and Patient B in the claims database, Patient A and Patient B must share at least three ICD codes.

An example of the retriever 202, the UID generator 204, the rarity assignor 206, the entity matcher 208 and/or the record matcher 210 is described in patent application Ser. No. 62/121,608, filed on Feb. 27, 2015, and entitled “Efficient Integration of De-Identified Records,” the entirety of which is incorporated herein by reference. Other approaches are also contemplated herein.

The database integration module 116 further includes a logic component 212. The logic component determines if an individual matched between the clinical and claims databases of different entities has a same UID as individuals in yet another entity. Generally, if it is known that Patient B also visited Hospital Z from the claims database, there will be a patient in the clinical database in Hospital Z that is a match for Patient B. As such, Patient B in the claims database of Hospital Z may have the same UID as individuals C, D and E in the clinical database of Hospital Z.

The database integration module 116 further includes a matching mitigator 214, which is used in response to the logic component 212 determining an individual matched between the clinical and claims databases of different entities has a same UID as multiple individuals in yet another entity. In one instance, the matching mitigator 214 uses clinical information to determine which one of the multiple individuals is the match. For example, if Patient A has a high serum creatinine baseline and/or other clinical characteristic, Patient C, D, or E with the high serum creatinine baseline is matched to Patient B.

The database integration module 116 further includes a longitudinal data adder 216. The longitudinal data adder 216 uses longitudinal information for an individual in the one database to create longitudinal information for the patient in another database that does not include the longitudinal information. In one instance, the longitudinal data adder 216 creates a visit key for a patient in the first type of database without longitudinal information to track the patient over his/her different visits. For example, if the patient has visited four times Physician A, three times Hospital I and four times Hospital II, all these ten visits will have the same visit key of, say, 1234. As such, it is known that all these ten visits are for the same patient. The integrated de-identified databases and/or the de-identified database with the newly added longitudinal information is stored in the databases 104 and/or other data repository.

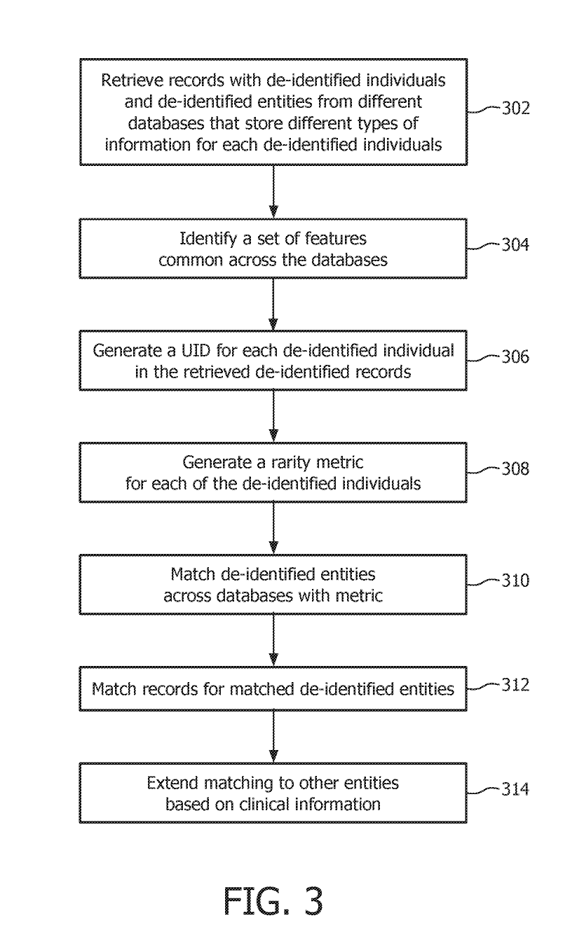

FIG. 3 illustrates an example method for integrating databases.

It is to be appreciated that the ordering of the acts in the methods described herein is not limiting. As such, other orderings are contemplated herein. In addition, one or more acts may be omitted and/or one or more additional acts may be included.

At 302, records with de-identified individuals and de-identified entities from at least two different de-identified databases, which store different types of information for each individual, are retrieved, as described herein and/or otherwise.

At 304, a set of features common across the at least two different de-identified databases is identified, as described herein and/or otherwise.

At 306, a UID is generated for each individual in the retrieved de-identified records using the set of patient features, as described herein and/or otherwise.

At 308, a rarity metric (e.g., coefficients, etc.) is generated for each of the de-identified individuals using the set of patient features, as described herein and/or otherwise.

At 310, de-identified entities are matched across the at least two different databases based on the rarity metric, as described herein and/or otherwise.

At 312, records for matched de-identified entities are matched between de-identified individuals, as described herein and/or otherwise.

At 314, the matching is extended across other entities based on clinical information, as described herein and/or otherwise.

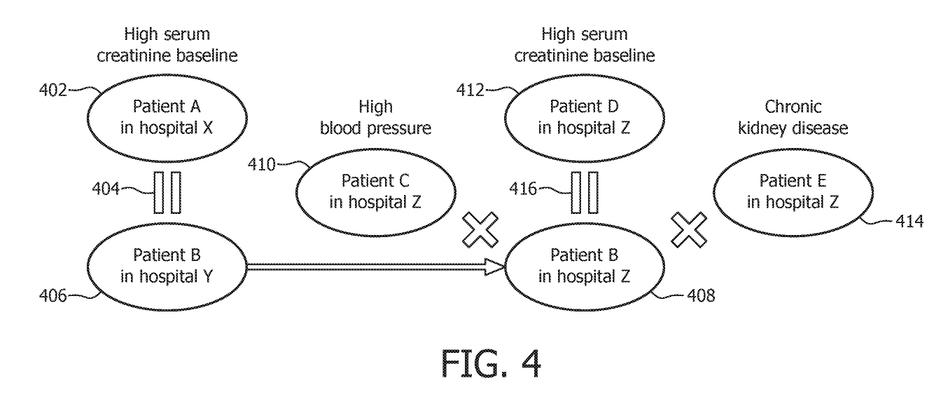

FIG. 4 depicts a non-limiting example of act 314 of FIG. 3. In FIG. 4, Patient A in a clinical database of hospital X (402) is matched (404) to Patient B in a claims database of hospital Y (406), as described herein and/or otherwise. However, Patient B in the claims database of hospital Z (408) has the same UID as Patients C, D and E in the clinical database of hospital Z (410, 412 and 414). Patients A, C, D and E have following clinical information: high serum creatinine baseline (Patient A); high blood pressure (Patient C); high serum creatinine baseline (Patient D), and chronic kidney disease (Patient E). As such, Patient B in the claims database of hospital Z (408) is matched 416 with Patient D in the clinical database of hospital Z (412).

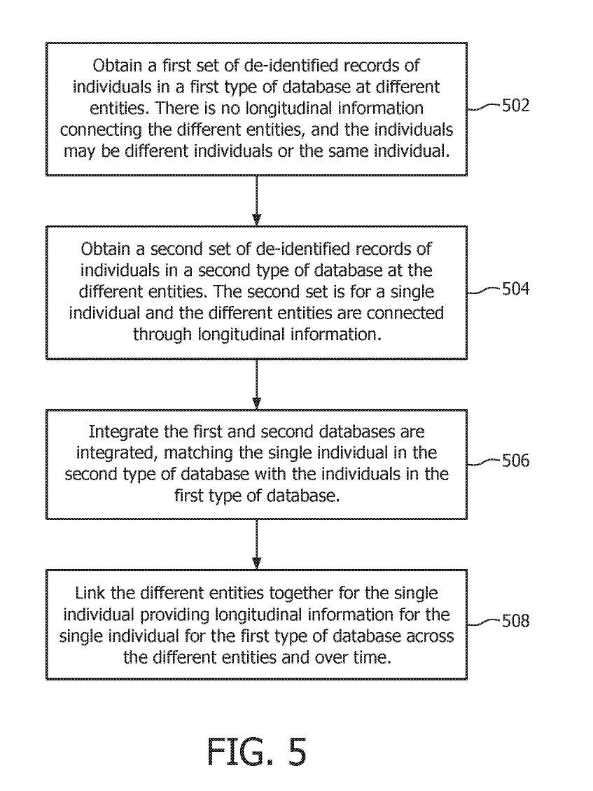

FIG. 5 illustrates an example method for adding longitudinal information to an integrated database.

It is to be appreciated that the ordering of the acts in the methods described herein is not limiting. As such, other orderings are contemplated herein. In addition, one or more acts may be omitted and/or one or more additional acts may be included.

At 502, a first set of de-identified records of individuals in a first type of database at different entities is obtained, where there is no longitudinal information connecting the different entities, and the individuals may be different individuals or the same individual. In this example, the individuals are the same individual.

At 504, a second set of de-identified records of individuals in a second type of database at the different entities is obtained, where the second set is for a single individual, and the different entities are connected through longitudinal information.

At 506, the first and second databases are integrated, as described herein and/or otherwise, by matching the single individual in the second type of database with the individuals in the first type of database.

At 508, the different entities are linked together for the single individual, providing longitudinal information for the single individual for the first type of database across the different entities and over time.

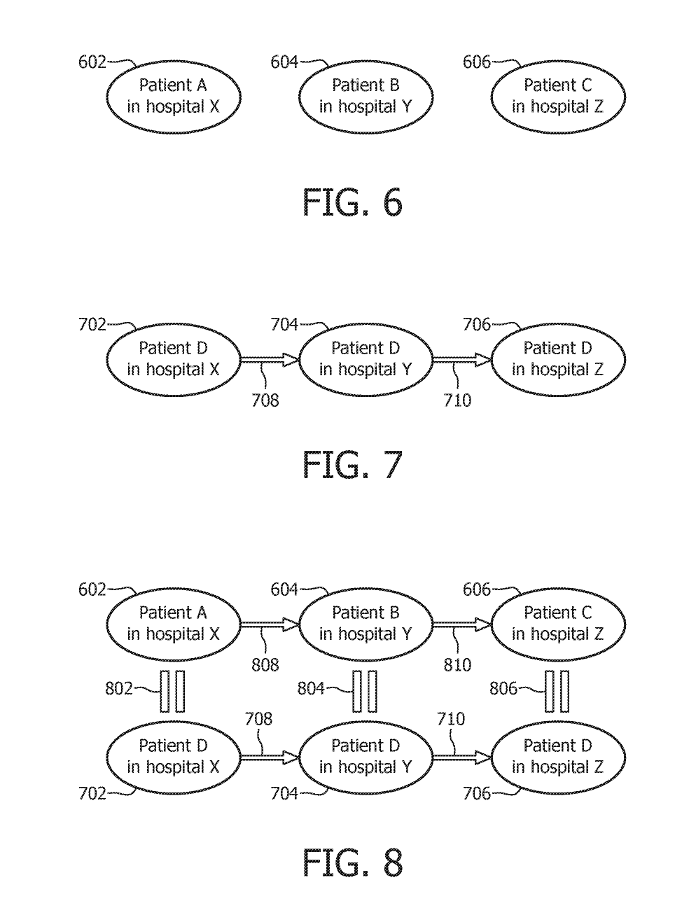

FIGS. 6, 7 and 8 depict a non-limiting example of FIG. 5.

FIG. 6 depicts an example of records for an individual in a first type of database across entities with no longitudinal information. In FIG. 6, records for a single individual in a clinical database are identified as Patient A of hospital X (602), Patient B of hospital Y (604), and Patient C of hospital Z (606) and are not connected through longitudinal information.

FIG. 7 depicts an example of records for the individual in a second type of database across the entities with longitudinal information. In FIG. 7, records for the single individual in a claims database are identified as Patient D of hospital X (702), Patient D of hospital Y (704), and Patient D of hospital Z (706) and are connected through longitudinal information (708, 710).

FIG. 8 depicts adding longitudinal information to the database of FIG. 6 through the integration of the database with the database of FIG. 7. In FIG. 8, the clinical and claims databases are integrated (802, 804, 806), allowing for adding longitudinal information (808, 810) to the clinical database based on the longitudinal information (708, 710).

The above may be implemented by way of computer readable instructions, which when executed by a computer processor(s), cause the processor(s) to carry out the described acts. In such a case, the instructions can be stored in a computer readable storage medium associated with or otherwise accessible to the relevant computer. Additionally or alternatively, one or more of the instructions can be carried by a carrier wave or signal.

The invention has been described herein with reference to the various embodiments. Modifications and alterations may occur to others upon reading the description herein. It is intended that the invention be construed as including all such modifications and alterations insofar as they come within the scope of the appended claims or the equivalents thereof.

What is claimed is:

1. A method, comprising:
receiving a first set of de-identified records for individuals from a first type of database for a first set of entities, wherein the first type of database does not include longitudinal information that links the first set of de-identified records across the first set of entities;
receiving a second set of de-identified records for a single individual from a second type of database for a second set of entities, wherein the second type of database includes longitudinal information that links the second set of de-identified records across the second set of entities including over time;
integrating the first type of databases and the second type of databases, which matches the individuals and the single individual; and
adding longitudinal information to the first type of database for the individuals based on the longitudinal information of the second type of database.

2. The method of claim 1, wherein the first set of de-identified records includes records without identities of the individuals and without identities of the first set of entities.

3. The method of claim 1, wherein the second set of de-identified records includes records without identities of the individual and without identities of the second set of entities.

4. The method of claim 1, wherein the adding of the longitudinal information includes creating a visit key that connects the first set of de-identified records for individuals across the first set of entities based on entity visit.

5. The method of claim 1, wherein the integrating of the first and second types of databases comprises:
identifying a set of features common across the first and second types of databases, wherein the set of features includes one or more of: age, race, mortality, gender, hospital length of stay, hospital discharge location, admission source, and diagnosis;
generating a unique identification for each of the individuals based on the set of features;
computing a rarity coefficient for each of the individuals based on the set of features;
matching entities of the first and second sets based on the rarity coefficients; and
matching individuals only of the matched entities by identifying individuals with a same unique identifier and that share a predetermined percentage of entity codes of the individual with a fewer number of the entity codes.

6. The method of claim 5, further comprising:
adding the longitudinal information for the single individual to the second type of database for the entities of the second set of entities with the matched individuals.

7. The method of claim 5, further comprising:
identifying the single individual has a record in the second type of database in a third entity;
identifying multiple individuals in the first type of database at the third entity as having a same unique identifier as the single individual;
identifying clinical information of the single individual in the first type of database and clinical information of each of the multiple individuals in the first type of database; and
matching the single individual to only one of the multiple individuals based on the clinical information of the single individual in the first type of database.

8. The method of claim 7, wherein only one of the multiple individuals has clinical information that matches the clinical information of the single individual; and further comprising:
matching the single individual to the one of the multiple individuals that has the clinical information that matches the clinical information of the single individual.

9. The method of claim 7, further comprising:
adding the longitudinal information for the single individual to the second type of database for the entities of the second set of entities with the matched individuals and the third entity.

10. The method of claim 1, wherein the at least two different entities are healthcare providers.

11. The method of claim 1, wherein the type of sources include two or more of administrative, operational, clinical, or claims.

12. A method, comprising:
receiving a first set of de-identified records for a first set of individuals from a first type of database for different entities;
receiving a second set of de-identified records for a second set of individuals from a second type of database for the different entities;
matching a first individual of the first type of database and a second individual of the second type of database that have a same unique identification and that share a predetermined percentage of entity codes of the individual with a fewer number of the entity codes;
identifying the second individual has a record in the second type of database at a third entity;
identifying multiple individuals in the second type of database at the third entity having a same unique identifier as the second individual;
identifying clinical information of the first individual and clinical information of each of the multiple individuals; and
matching the first individual to only one of the multiple individuals based on the clinical information.

13. The method of claim 12, wherein only one of the multiple individuals has clinical information that matches the clinical information of the single individual; and further comprising:
matching the single individual to the one of the multiple individuals that has the clinical information that matches the clinical information of the single individual.

14. The method of claim 12, further comprising:
generating a unique identification for each of the individuals based on a set of features common across the at least two different databases;
computing a rarity coefficient for each of the individuals based on the set of features;
matching entities across the first and second types of databases based on the rarity coefficient; and
matching, across only for the matched entities, the first individual of the first type of database and the second individual of the second type of database.

15. The method of claim 12, wherein one of: the first type of databases is linked across the entities for an individual through longitudinal information and the second type of databases is not; or the second type of databases is linked across the entities for the individual through the longitudinal information and first type of databases, and further comprising:
adding the longitudinal information to the other of the first type of databases or the second type of databases.

16. The method of claim 15, wherein the adding of the longitudinal information includes creating a visit key to connect the individuals in the databases over multiple different entity visits.

17. The method of claim 13, wherein the at least two different entities are healthcare providers.

18. The method of claim 13, wherein the type of sources include two or more of administrative, operational, clinical, or claims.

19. A computing system, comprising:
a memory device configured to store instructions, including a record integration module; and
a processor that executes the instructions, which causes the processor to:
receive a first set of de-identified records for individuals from a first type of database for different entities, wherein the first type of database does not include longitudinal information;
receive a second set of de-identified records for a single individual from a second type of database for the different entities, wherein the second type of database includes longitudinal information, wherein the longitudinal information links the second set of de-identified records across the different entities and over time;
integrate the first and second types of databases by matching the individuals and the single individual; and
add the longitudinal information of the second type of database to the first type of database for the individuals.

20. The computing system of claim 19, wherein the different entities include a first set of de-identified entities with the first type of database and a second set of de-identified entities with the second type of database, and the processor further:
identifies a set of features common across the at least two different databases;
generates a unique identification for each of the individuals based on the set of features;
computes a rarity coefficient for each of the individuals based on the set of features;
matches entities of the first and second sets of the de-identified entities across the first and second types of databases based on the rarity coefficients;
identifies the single individual has a record in the second type of database at a third entity;
identifies multiple individuals in the first type of database at the third entity as having the same unique identifier as the single individual;
identifies clinical information of the single individual and clinical information of each of the multiple individuals; and
matches the single individual to only one of the multiple individuals based on the clinical information.
